(19) United States
(12) Patent Application Publication
(10) Pub. No.: US 2021/0323866 A1
(43) Pub. Date: Oct. 21, 2021

(54) HEAT GENERATING COMPOSITIONS

(71) Applicant: AXIS INNOVATION PTY LTD, Woodville North (AU)

(72) Inventors: Philip Anthony Scardigno, Woodville North (AU); Stylianos Steven Pehlivanides, Woodville North (AU)

(73) Assignee: AXIS INNOVATION PTY LTD, Woodville North (AU)

(21) Appl. No.: 17/264,977

(22) PCT Filed: Aug. 1, 2019
(86) PCT No.: PCT/AU2019/000093

§ 371 Date: Feb. 1, 2021

(30) Foreign Application Priority Data
Aug. 2, 2018 (AU) 2018902819
Apr. 24, 2019 (AU) 2019901404

(51) Int. Cl. C04B 14/38; C04B 28/04; C04B 28/06; C04B 14/02; C09J 175/04; C09J 163/00; C09J 9/02; C09D 5/02; C09D 5/24; C09D 183/04

(52) U.S. Cl. CPC C04B 14/386; C04B 28/04; C04B 28/06; C04B 14/024; C04B 14/026; C04B 2111/94; C09J 163/00; C09J 9/02; C09D 5/028; C09D 5/24; C09D 183/04; C09J 175/04

(57) ABSTRACT

A composition configured to form a heat generating layer on a building element is disclosed. The composition includes a base material and an electrically conductive filler, wherein the composition is configured to form a heat generating layer after it has been applied to a surface of the building element. The composition may be a construction adhesive or jointing composition, a gel coat composition or a bedding or self-levelling composition.

### PRIORITY DOCUMENTS

The present application claims priority from:
Australian Provisional Patent Application No. 2018902819 titled “A HEAT GENERATING COATING, A BUILDING ELEMENT AND A HEATING SYSTEM EMPLOYING THE SAME” and filed on 2 Aug. 2018; and
Australian Provisional Patent Application No. 2019901404 titled “HEAT GENERATING COMPOSITIONS” and filed on 24 Apr. 2019.

The content of each of these applications is hereby incorporated by reference in its entirety.

### TECHNICAL FIELD

The present disclosure relates to adhesive and/or coating and/or gel coat compositions that are able to generate heat when connected to a source of electricity.

### BACKGROUND

Electrothermic materials generate heat when they are connected to a source of electricity. Electrically conductive paints that incorporate electrothennic materials are known in the art and have been proposed for use in many applications, such as radiant emitters that heat and/or maintain the temperature of an object in a target environment (see for example GB2556066 (A)). However, to the best of the applicant's knowledge, known coatings typically only generate low amounts of heat and often break down at moderate to high temperatures.

DE202010009208 (U1) and DE202014009744 (U1) disclose surface coating compositions, such as paint, for coating a surface. The compositions comprise a base material and conductivity additives in the base material. The conductivity additives generate heat when an electric current is applied to a coating that is formed from the composition.

U.S. Pat. No. 6,818,156B1 discloses a coating composition, such as paint, that emits heat without breaking down when connected to a source of electricity, which comprises a binder, an electrically conductive carbon black particle generated by high temperature pyrolysis of acetylene, an electrically conductive graphite particle having a degree of crystallinity of at least about 67%, and a volatile solvent.

WO2018078087 (A1) discloses a paint that can be used to produce a surface heating coating on a wall. The disclosed paint comprises at least two conductivity additives including graphite and carbon black, and a binder. The paint is free of electrically conductive carbon fibres and carbon nanotubes.

The paint and coating compositions disclosed in each of the aforementioned prior art documents suffer from several drawbacks. For example, many of the compositions are used as paints and the physical and aesthetic requirements of paints means that there is limited scope for inclusion of conductivity additives into the composition without compromising one or more physical and/or aesthetic properties of the composition after it has been applied as a coating on a surface. For example, paint compositions cannot be highly loaded with carbon black particles without affecting the properties of the composition before or after application.

Furthermore, due to the tendency of electrically conductive fibrous materials such as carbon black or carbon nanotubes to self-gather, it is expensive and difficult to prepare a substantially homogeneous dispersion within which these materials are evenly distributed (see for example DE 20 2010 009 208 U1 and DE 20 2014 009 744 U1). As a result, these dispersions are not very stable and tend to gather again over time.

In addition, existing electrothermic compositions are not waterproof and they generally require an additional waterproof sealant to be applied under and/or upon a layer of the electrothermic composition to provide waterproof properties to an applied surface.

It is against this background and the problems and difficulties associated therewith that the heat generating compositions of the present disclosure, and processes for preparing them, have been developed.

### SUMMARY

According to a first aspect, there is provided a composition capable of forming a heat generating layer on a building element, the composition comprising a base material and an electrically conductive filler, wherein the composition is capable of forming a heat generating layer after it has been applied to a surface of the building element.

According to a second aspect, there is provided a heat generating building element comprising a heat generating layer comprising a base material and an electrically conductive filler.

In certain embodiments of the second aspect, the building element further comprises at least a pair of electrodes at spaced apart positions on or adjacent to at least one surface thereof, and wherein the heat generating layer electrically bridges the electrodes.

According to a third aspect, there is provided a heating system comprising a building element of the second aspect and an electrical circuit comprising an electrical power source and a switch, in connection with the electrodes.

According to a fourth aspect, the composition capable of forming a heat generating layer of the first aspect is a construction adhesive or jointing composition capable of joining two surfaces, the adhesive or jointing composition comprising a base material and an electrically conductive filler, wherein the adhesive or jointing composition is capable of forming a heat generating adhesive or jointing material between the two surfaces in interior and exterior applications.

In certain embodiments of the fourth aspect, the construction adhesive or jointing composition is capable of forming a waterproof heat generating adhesive or jointing material between the two surfaces in interior and exterior applications.

According to a fifth aspect, there is provided a heat generating coating formed from the construction adhesive or jointing composition of the fourth aspect.

According to a sixth aspect, there is provided a building element comprising the heat generating coating formed from the construction adhesive or jointing composition of the fourth aspect and at least a pair of electrodes at spaced apart positions on or adjacent to at least one surface thereof, wherein the heat generating coating electrically bridges the electrodes.

According to a seventh aspect, the composition capable of forming a heat generating layer of the first aspect is a gel coat composition capable of forming an article after curing, the gel coat composition comprising a curable polymer precursor and electrically conductive fibres, wherein the gel coat composition is capable of forming a heat generating shaped article for interior and exterior applications after curing.

In certain embodiments of the seventh aspect, the gel coat composition is capable of forming a waterproof heat generating shaped article for interior and exterior applications.

According to an eighth aspect, there is provided a heat generating shaped article for interior and exterior applications formed from the gel coat composition of the seventh aspect.

According to a ninth aspect, the composition capable of forming a heat generating layer of the first aspect is a bedding or self-levelling composition, the bedding or self-levelling composition comprising a base material and an electrically conductive filler, wherein the bedding or self-levelling compound is capable of forming a heat generating layer after it has been applied to a surface of the building element.

According to a tenth aspect, there is provided a heat generating bedding or self-levelling layer formed from the bedding or self-levelling of the ninth aspect.

According to an eleventh aspect, there is provided a building element comprising the heat generating bedding or self-levelling layer formed from the bedding or self-levelling of the ninth aspect and at least a pair of electrodes at spaced apart positions on or adjacent to at least one surface thereof, wherein the heat generating coating electrically bridges the electrodes.

### BRIEF DESCRIPTION OF DRAWINGS

Embodiments of the present disclosure will be discussed with reference to the accompanying drawings wherein:

FIG. 1 is a schematic of a heat generating building element comprising a heat generating layer comprising a base material and an electrically conductive filler.

### DESCRIPTION OF EMBODIMENTS

Disclosed herein is a composition capable of forming a heat generating layer on a building element. The composition comprises a base material and an electrically conductive filler and is capable of forming a heat generating layer after it has been applied to a surface of the building element. In certain embodiments, the composition is adapted to form the heat generating layer between a surface of the building element and a covering layer. For example, the covering layer may comprise a floor or wall covering.

The composition may be a construction adhesive or jointing composition capable of joining two surfaces, the adhesive or jointing composition comprising a base material and an electrically conductive filler, wherein the adhesive or jointing composition is capable of forming a heat generating adhesive or jointing material between the two surfaces in interior and exterior applications.

Alternatively, the composition may be a gel coat composition capable of forming an article after curing, the gel coat composition comprising a curable polymer precursor and electrically conductive fibres, wherein the gel coat composition is capable of forming a heat generating shaped article for interior and exterior applications after curing.

Alternatively still, the composition may be a bedding or self-levelling composition, the bedding or self-levelling composition comprising a base material and an electrically conductive filler, wherein the bedding or self-levelling compound is capable of forming a heat generating layer after it has been applied to a surface of the building element.

Depending on the base material used, the solvent (if any) that is used, and the nature of any additional components of the composition, the heat generating composition disclosed herein can be used in a range of applications, including as a solvent based adhesive, as a polymer dispersion adhesive, as a cement based adhesive, as a sealant, as a gel coat composition, as a bedding composition or as a self-levelling compound. Specific applications of the heat generating composition include, but are not limited to, ceramic floor and wall tile adhesives, vinyl sheet/tile adhesives, timber flooring adhesives, parquet fixing adhesives, carpet tile/flooring adhesives, floor and wall panel adhesives, and general fixing adhesives for floor and wall surface finishes. Each of these applications is discussed in more detail later.

In certain embodiments, the heat generating construction adhesive or jointing compositions, the gel coat compositions or the bedding or self-levelling compositions disclosed herein, are capable of forming waterproof layers on building elements or waterproof shaped articles. However, it will also be appreciated that there are applications for which a waterproof material is not required and non-waterproof construction adhesive or jointing compositions, gel coat compositions or bedding or self-levelling compositions of the present disclosure, can be used for those particular applications.

The heat generating composition comprises an electrically conductive filler which is a material that generates heat when an electric current is applied. The electrically conductive filler may be a carbon and/or graphite based material. The carbon and/or graphite based material may be selected from any one or more of carbon nanotubes, carbon fibres, graphene, graphite and carbon black. Alternatively, the electrically conductive filler may be metal-based particles. The electrically conductive filler may be in the form of platelets, tubes, fibres, and combinations thereof. Alternatively, the electrically conductive filler may be in the form of a carbon fibre mesh, grid or cloth. The electrically conductive filler may be present in the composition in an amount of from about 0.1 wt % to about 25 wt %.

Advantageously, the present applicant has found that a range of electrically conductive fillers can be incorporated into a range of polymeric resin base materials and cement base materials to produce a range of adhesive, sealant, gel coat and bedding or self-levelling compositions.

In certain embodiments, the heat generating composition is a construction adhesive or jointing composition capable of joining two surfaces. A range of polymeric resins can be used in the construction adhesive or jointing composition and the choice of polymeric resin will depend, at least in part, on the intended end use of the composition. Organic polymeric resins that can be used include, but are not limited, to styrene butadiene rubber, styrene acrylic, acrylic, vinyl acetates, polyurethane dispersion based, polyurethane moisture cured based, modified silicone, silicone, cement based, epoxy based, latex based polymers, polyureas, methyl methacrylate resins, polyaspartic resins, polyester resins, general polymers used in liquid membranes/coatings, cross linked polymer systems, and single component and two component systems. The polymeric resin could also be an inorganic polymeric resin, such as a geopolymer formed from fly ash and silicates.

The polymeric resins can be liquids, gels, re-dispersible powder polymers, cement based, etc.

The polymeric resins may be polymerised, partially polymerised or un-polymerised. The polymerised and partially polymerised polymeric resins may be part of a single component composition. Partially polymerised and un-polymerised resins may be part of a two component composition that further comprises a curing agent. The curing agent may be selected from water, dibutyltin, dibutyltin dilaurate, methyltrioximinosilane, polyamines (such as diethylenetriamine, triethylenetetramine, tetraethylenepentamine, tetraethylenepentamine, diethylaminopropylamine, N-aminoethylpiperazine, menthane diamine, isophoronediamine), polyamides (such as those formed by reaction of a dimer acid and a polyamine), tertiary aromatic amines (such as 2,4,6-tris-(dimethylaminomethyl) phenol, benzyldimethylamine, 2-(dimethylaminomethyl)phenol), peroxides, cements, and pozzolanic compounds.

If present, the solvent may be water, an aqueous solvent, or an organic solvent. Suitable organic solvents include chloroform, methanol, ethanol, and toluene.

The construction adhesive or jointing composition can be formed by mixing the electrically conductive filler with the base material and any other components under rapid stirring conditions.

In certain embodiments, the construction adhesive or jointing composition is a cement based adhesive. The cement based adhesive is of the type that is suitable as an adhesive for ceramic tiles and stone tiles. The cement based adhesive may be in a powdered solid form.

The cement based adhesive comprises an inorganic binder selected from the group consisting of cement, lime, gypsum, concrete, silica, and combinations thereof. A polymeric resin comprising a re-dispersible powder polymer or liquid polymer is added.

The cement based adhesive may also comprise one or more additives, as required or as known in the art. For example, the cement based adhesive may comprise a modifier such as a retardant. Cellulose ethers, such as Methocel™ or hydroxyethyl methyl cellulose (HEMC), can be used as modifiers. The cement based adhesive may also comprise a surfactant. Suitable surfactants for this purpose are known in the art and include, for example, dodecyl benzene sodium sulfonate (DBSS).

In certain other embodiments, the construction adhesive or jointing composition is a moisture cured adhesive. The base material of the moisture cured adhesive may be a polymeric resin such as a polyurethane.

The moisture cured adhesive may also comprise one or more additives, as required or as known in the art. For example, the moisture cured adhesive may also comprise a plasticiser (diisodecyl phthalate is an example), a moisture scavenger or crosslinker (vinyltrimethoxysilane is an example), a filler (calcium carbonate is an example), a thixotropic agent (fumed silica is an example), a pigment (titanium dioxide is an example), an adhesion promoter (3-aminopropyltrimethoxysilane is an example) and/or a catalyst (dibutyl tin is an example).

In certain other embodiments, the construction adhesive or jointing composition is a sealant composition. The base material of the sealant composition comprises a polymeric resin selected from silicone, modified silicone, acrylic polymers, polyurethane, epoxy resin, and polyester. The polymeric resin is cross linkable. The sealant composition may be a two-component composition.

The sealant composition may also comprise one or more additives, as required or as known in the art. For example, the sealant composition may also comprise a plasticiser (polydimethylsiloxane-trimethyl terminate is an example), a crosslinker (methyltrioximinosilane is an example), a filler (calcium carbonate is an example), a filler (fumed silica is an example), an adhesion promoter (3-aminopropyltrimethoxysilane is an example) and/or a catalyst (dibutyl tin laurate is an example).

The sealant composition is applicable to caulking joints, sealing panel joints, fabrication joints, movement and expansion joints, flexible or non-movement gas and joints.

In certain other embodiments, the construction adhesive or jointing composition is a two-component adhesive. The base material of the two-component adhesive may be a two-part composition, with the first part comprising a polyhydroxy compound, such as a triol, and the second part comprising diisocyanate. Mixing of the first part with the second part results in curing by reaction of the triol and the isocyante to thereby form a polymeric resin base material. Either part of the two-part composition may comprise a solvent, such as an alcohol solvent.

In certain other embodiments, the construction adhesive or jointing composition is a two-component adhesive. The base material of the two-component adhesive may be a two-part composition, with the first part comprising one or more cement based materials, such as Portland cement, and the second part comprising one or more pozzolanic materials. Pozzolanic materials that can be used include, but are not limited to, fly ash (both Class C fly ash and Class F fly ash), blast furnace slag, and natural pozzolanic materials such as calcined clay, calcined shale, metakaolin, volcanic ash, volcanic glass (pumicite and obsidian) and rice husk ash. Mixing of the first part with the second part results in curing to thereby form a cement based adhesive.

In certain other embodiments, the construction adhesive or jointing composition is a two-component epoxy adhesive. The base material of the two-component adhesive may be a two-part composition, with the first part comprising an epoxy resin, and the second part comprising a polyamine or polyamide. Mixing of the first part with the second part results in curing by reaction of the polyamine or polyamide and the epoxy to thereby form a polymeric resin base material. Either part of the two-part composition may comprise a solvent, such as an alcohol solvent.

A gel coat composition, such as for use in fibreglass, is also disclosed herein. The gel coat composition comprises a polymeric resin that is curable. The polymeric resin is selected from or made from a cross linkable polymer system, thermoset polymer matrix composites, saturated and unsaturated polyesters, epoxy resins, thermosetting polymers, such as acrylic polymers. The gel coat composition comprises a carbon fibre based electrically conductive filler. The gel coat composition may be in a two-component form.

The gel coat composition can be used in the preparation of a wide range of substrates, such as bathtubs, bathroom walls, fibreglass pools, fibreglass boats, fibreglass tanks, kitchen sinks, etc.

A bedding or self-levelling composition is also disclosed herein. The bedding or self-levelling composition comprises a base material and an electrically conductive filler. The bedding or self-levelling compound is capable of forming a heat generating layer after it has been applied to a surface of a building element.

The construction adhesive or jointing composition, gel coat composition or bedding or self-levelling composition described herein may further comprise one or more additives. Additives that may be included include, but are not limited to, dispersing agents, wetting agents, surfactants, plasticisers, moisture scavengers, cross linkers, fillers, thixotropic agents, anti-precipitation agents, coupling agents, colourants, pigments, adhesion promoters, catalysts, diluents, solvents, anti-foaming agents, etc.

The composition can be applied to a vertical surface, a horizontal surface or any other surface by brush coating, roller coating, curtain coating, spray coating, etc. A desired thickness of coating/layer may be achieved in a single application of the composition or it may be built up over multiple applications.

The composition can be applied to any substrate or building element. In one form, the building element is a floor or wall. In another form, the building element is a panel. This could be either of a wall or ceiling panel.

In certain embodiments, the base of the building element is comprised of plasterboard (or drywall). Such a panel typically consists of a layer of gypsum plaster sandwiched between two layers of paper.

In certain embodiments, the building element is a brick.

In certain embodiments, the building element is a tile.

In certain embodiments, the building element is floor plank or hoard.

In certain embodiments, the substrate comprises a concrete stricture or foundation. In this form, the system provides an under floor heating system beneath floor finishes such as tiles. In this form, the system also provides a wall heating system beneath wall finishes such as tiles.

In certain embodiments, one or more thermal insulation layers may be used between the building element and the heat generating layer formed from the compositions described herein. The thermal insulation layer can be any material that prevents or minimises heat transfer from the heat generating layer to the underlaying substrate of the building element. Suitable thermal insulation layers known for this purpose in the art can be used.

In certain embodiments, the composition is adapted to provide a waterproof membrane.

In certain embodiments, the composition is adapted to provide an anti-fracture or de-coupling floor system.

In certain embodiments, the composition is adapted to provide a protective coating.

In certain embodiments, the composition is adapted to provide an acoustic membrane.

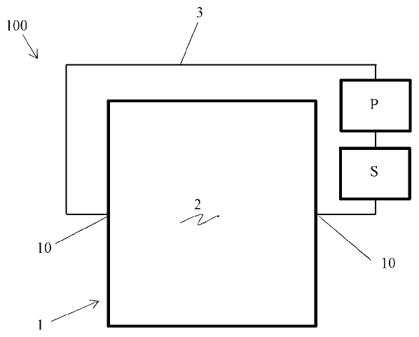

Typically, the building element comprises at least a pair of electrodes at spaced apart positions on or adjacent to at least one surface thereof, and wherein a heat generating layer formed from the composition electrically bridges the electrodes. Referring now to FIG. 1, a heating system 100 comprises a building element 1 comprising a heat generating layer 2 and an electrical circuit 3 comprising a low current electrical power source P (AC or DC) and a switch S, in connection with the electrodes 10. This heating system 100 may comprise a plurality of the building elements 1 electrically connected to each other via their respective electrodes 10 and forming part of the electrical circuit 3. These electrical connections may be created along either of the side edges or the top and bottom edges of the building element 1. The switch S may incorporate means for adjusting the amount of heat emitted.

Use of the heat generating compositions described herein makes a useful alternative to current under floor heating systems that require cables and penetration through waterproof membranes in wet area applications.

The construction adhesive or jointing composition, gel coat compositions or bedding or self-levelling compositions described herein have several advantages over known compositions including, but not limited to:
They are dual function waterproof and heat generating systems when used under surface finishes for both interior and exterior applications, wall and flooring;
They are able to withstand permanently wet conditions;
They can be used as a trafficable that can withstand both chemicals and water, as a waterproof and hard wearing traffic system;
The gel coat can be used for any fibreglass structural element such as panels, pools, etc;
Relatively large particle size electrically conductive fillers can be used (especially compared to paint coating compositions); and
High loadings of electrically conductive fillers can be used (especially compared to paint coating compositions).

### EXAMPLES

The present disclosure will now be illustrated by reference to the following non-limiting examples.

### Example 1—Cement Based Tile Adhesive

A cement based tile adhesive was formed using the components shown in Table 1.

TABLE 1

| | Amount | |
|---|---|---|
| Component | (wt %) | Function |
| Ordinary Portland Cement (OPC) | 25.0-50.0% | |
| Silica sand | 40.0-60.0% | |
| Calcium formate | 0.2-5.0% | |
| Cellulosic modifier | 0.2-5.0% | |
| Carbon fibre or graphite or multi | 0.1-25.0% | Electrically |
| wall carbon nanotubes (MWCNT) | | conductive |
| or carbon mesh or grid | | filler |
| Redispersible polymer | 1.0-20.0% | |
| Surfactant | 1.0-5.0% | |

The components listed in Table 1 were added in sequence with high speed mixing to produce a tile based adhesive that generates heat when an electric current is applied to the adhesive.

### Example 2—Single-Component Flooring Adhesive

A moisture cured flooring adhesive was formed using the components shown in Table 2.

TABLE 2

| | Amount | |
|---|---|---|
| Component | (wt %) | Function |
| Silane terminated polyurethanes | 20-30% | Polymer |
| Diisodecyl phthalate | 10-20% | Plasticiser |
| Vinyltrimethoxysilane | 0.3-0.9% | Moisture |
| | | scavenger/ |
| | | crosslinker |
| Carbon fibre or graphite or MWCNT | 0.1-25% | Electrically |
| or carbon black or carbon mesh | | conductive |
| or grid | | filler |
| Calcium carbonate | 30-60% | Filler |
| Fumed silica | 0.1-3% | Thixotropic agent |
| Titanium dioxide | 1-5% | Pigment |
| 3-Aminopropyltrimethoxysilane | 1-5% | Adhesion promoter |
| Dibutyl tin | 0.2-1% | Organic tin catalyst |

The components listed in Table 2 were added in sequence with high speed mixing to produce a flooring adhesive that generates heat when an electric current is applied to the adhesive.

### Example 3—Silicone Sealant—Neutral Cure

A silicone sealant was formed using the components shown in Table 3.

TABLE 3

| | Amount | |
|---|---|---|
| Component | (wt %) | Function |
| Polydimethylsiloxane-OH | 50-70% | Polymer |
| terminated | | |
| Polydimethylsiloxane-trimethyl | 10-30% | Plasticiser |
| terminate | | |
| Methyltrioximinosilane | 2.5-10% | Crosslinker |
| Aminopropyltriethoxysilane | 1-10% | Adhesion promoter |
| Carbon fibre or graphite or | 0.1-25% | Electrically conductive |
| MWCNT or carbon mesh or grid | | filler |
| Fumed silica | 5-15% | Filler |
| Dibutyltin dilaurate | 0.1-1% | Catalyst |

The components listed in Table 3 were added in sequence with high speed mixing to produce a sealant that generates heat when an electric current is applied to the sealant.

### Example 4—Two-Component Flooring Adhesive

A 2K polyurethane wood parquet flooring adhesive was formed using the components shown in Table 4.

TABLE 4

| | | |
|---|---|---|
| | Amount | |
| Component | (wt %) | Function |

Part A:

| | | |
|---|---|---|
| OH-terminated polyether triol | 10-40% | Polymer |
| Calcium carbonate | 30-60% | Filler |
| Carbon fibre or graphite or | 0.1-25% | Electrically |
| MWCNT or carbon mesh or grid | | conductive |
| | | filler |
| 1,4-Butandiol | 1-20% | Diluent |

Part B:

| | | |
|---|---|---|
| Diphenylmethane-diisocyanate | 30-60% | Isocyanate |
| Carbon fibre or graphite or | 0.1-25% | Electrically |
| MWCNT or carbon mesh or grid | | conductive |
| | | filler |
| Poly (propylene oxide) triol low | 0.1-2% | Reactive |
| mole wt | | |

The Part A components listed in Table 4 were added in sequence with high speed mixing to produce Part A of a two-component flooring adhesive. The Part B components listed in Table 4 were added in sequence with high speed mixing to produce Part B of a two-component flooring adhesive. In use, Part A and Part B are mixed to produce an adhesive composition that generates heat when an electric current is applied to the adhesive.

### Example 5—Two-Component Epoxy Resin Adhesive

An epoxy resin adhesive composition was formed using the components shown in Table 5.

TABLE 5

| | | |
|---|---|---|
| | Amount | |
| Component | (wt %) | Function |

Part A:

| | | |
|---|---|---|
| Epoxy resin | 50-90% | |
| Reactive Diluent | 1-10% | Epoxy diluent/ |
| | | crosslinker |
| Anti-foaming agent 3.8 | 1-5% | De-foamer |
| Carbon fibre or graphite or | 0.1-25% | Electrically |
| MWCNT or carbon mesh or grid | | conductive |
| | | filler |

Part B:

| | | |
|---|---|---|
| Polyamine or polyamide | 20-40% | Epoxy hardener |
| Tertiary aromatic amine | 0.1-3% | Crosslinker |
| Fillers Quartz sand | 25-45% | Filler |
| Fillers quartz flour | 10-20% | |
| Carbon fibre or graphite or | 0.1-25% | Electrically |
| MWCNT or carbon mesh or grid | | conductive |
| | | filler |
| Calcium carbonate | 1-3% | Pigment |

The Part A components listed in Table 5 were added in sequence with high speed mixing to produce Part A of an epoxy resin adhesive. The Part B components listed in Table 5 were added in sequence with high speed mixing to produce Part B of an epoxy resin adhesive. In use, Part A and Part B are mixed to produce an adhesive composition that generates heat when an electric current is applied to the adhesive.

### Example 6—Self-Levelling Composition

A self-leveller guide point composition was formed using the components shown in Table 6.

TABLE 6

| | Amount |
|---|---|
| Component | (wt %) |
| OPC Cement 32.5R | 10-20% |
| HAC high alumina cement | 15-30% |
| Silica sand (0.06 mm-0.35mm) | 30-50% |
| Fly ash | 15-25% |
| Re-dispersible polymer | 5-15% |
| Lithium carbonate | 0.5-2.0% |
| Sodium gluconate | 0.5-2.0% |
| Plasticiser | 3-7% |
| Cellulose ether | 0.5-1.5% |
| Carbon fibre/graphite or multi wall | 0.1-25.0% |
| carbon nanotubes (MWCNT) or | |
| carbon mesh or grid | |
| Anhydrite | 5-10% |
| Defoamer | 0.5-2% |
| Fibre 1-4 mm | 5% |

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A composition configured to form a heat generating layer on a building element, the composition comprising: a base material and an electrically conductive filler, wherein the composition is configured to form a heat generating layer after it has been applied to a surface of the building element.

2. The composition according to claim 1, wherein the heat generating layer is waterproof.

3. The composition according to claim 1, wherein the electrically conductive filler is present in an amount of from about 0.1 wt % to about 25 wt %.

4. The composition according to claim 1, wherein the electrically conductive filler is a carbon and/or or graphite based material.

5. The composition according to claim 4, wherein the carbon or graphite based material is selected from the group consisting of carbon nanotubes, carbon fibres, graphene, graphite, and carbon black.

6. The composition according to claim 1, wherein the average size of at least one dimension of the electrically conductive filler particles is 1 nm or greater.

7. The composition according to claim 6, wherein the average size of at least one dimension of the electrically conductive filler particles is 500 microns or greater.

8. The composition according to claim 4, wherein the carbon or graphite based material is selected from the group consisting of carbon mesh, carbon grid and carbon cloth.

9. A construction adhesive or jointing composition configured to join two surfaces, the adhesive or jointing composition comprising: the composition according to claim 1, wherein the adhesive or jointing composition is configured to form a heat generating adhesive or jointing material between the two surfaces in interior and exterior applications.

10-16. (canceled)

17. A heat generating coating formed from the construction adhesive or jointing composition according to claim 9.

18. A building element comprising: the heat generating coating according to claim 17, and at least a pair of electrodes at spaced apart positions on or adjacent to at least one surface thereof, wherein the heat generating coating electrically bridges the electrodes.

19. A gel coat composition configured to form an article after curing, the gel coat composition comprising: the composition according to claim 1, wherein the base material is a curable polymer precursor and the electrically conductive filler is electrically conductive fibres, wherein the gel coat composition is configured to form a heat generating shaped article for interior and exterior applications after curing.

20-26. (canceled)

27. A heat generating shaped article for interior and exterior applications formed from the gel coat composition according to claim 19.
